(19) United States
(12) Patent Application Publication
(10) Pub. No.: US 2025/0329503 A1
(43) Pub. Date: Oct. 23, 2025

(54) SOLID ELECTROLYTIC CAPACITOR

(71) Applicant: Panasonic Intellectual Property Management Co., Ltd., Osaka (JP)

(72) Inventors: SYUSAKU KOIE, Shiga (JP); KENJI KURANUKI, Kyoto (JP); KOJI TAKAHASHI, Kanagawa (JP); HIROYUKI HANDA, Osaka (JP); NOBORU NEGORO, Osaka (JP)

(21) Appl. No.: 19/257,593

(22) Filed: Jul. 2, 2025

Related U.S. Application Data
(63) Continuation of application No. PCT/JP2024/000632, filed on Jan. 12, 2024.

(30) Foreign Application Priority Data
Jan. 24, 2023 (JP) 2023-008713

(51) Int. Cl. H01G 9/14; H01G 9/012; H01G 9/028; H01G 9/15

(52) U.S. Cl. CPC H01G 9/14; H01G 9/012; H01G 9/15; H01G 9/028

(57) ABSTRACT

A solid electrolytic capacitor includes: a plurality of capacitor elements stacked on each other, each of the plurality of capacitor elements including an anode body and a cathode part; two anode terminals electrically connected to the anode body; a cathode terminal electrically connected to the cathode part; and an outer packaging resin. The anode body has two protrusions respectively protruding from both ends of the cathode part. Each of the two protrusions is electrically connected to a corresponding one of the two anode terminals. The two protrusions in each of the plurality of capacitor elements are electrically connected to each other. The cathode part includes a first portion having a first width and a second portion having a second width smaller than the first width. The cathode terminal includes a first side wall electrically connected to a side surface of the second portion of the cathode part.

### BACKGROUND

### 1. Technical Field

The present disclosure relates to a solid electrolytic capacitor.

### 2. Description of the Related Art

Conventionally, a surface mount capacitor called a transmission line type noise filter is known (for example, Unexamined Japanese Patent Publication No. 2009-076651). The surface mount capacitor of Unexamined Japanese Patent Publication No. 2009-076651 includes a box-shaped resin mold case base, a plurality of stacked capacitor elements each having both ends and a central part, and a box-shaped case lid, both ends each having an anode, the central part having a cathode. The surface mount capacitor further includes a metal plate that is locked to the inside of the case lid and compensates for conduction of the cathodes of the capacitor elements as necessary.

### SUMMARY

One aspect of the present disclosure relates to a solid electrolytic capacitor. The solid electrolytic capacitor includes: a plurality of capacitor elements stacked on each other, each of the plurality of capacitor elements including an anode body and a cathode part formed on a surface of the anode body via a dielectric layer; two anode terminals electrically connected to the anode body; a cathode terminal electrically connected to the cathode part; and an outer packaging resin that covers the plurality of capacitor elements, the two anode terminals, and the cathode terminal so that a part of each of the two anode terminals and a part of the cathode terminal are exposed from the outer packaging resin. The anode body has two protrusions, one of the two protrusions protruding from one of both ends of the cathode part, another one of the two protrusions protruding from another one of the both ends of the cathode part. Each of the two protrusions is electrically connected to a corresponding one of the two anode terminals. The two protrusions in each of the plurality of capacitor elements are electrically connected to each other. The cathode part includes a first portion having a first width and a second portion having a second width smaller than the first width. The cathode terminal includes a first side wall electrically connected to a side surface of the second portion of the cathode part.

According to the present disclosure, noise filter characteristics can be improved.

Although novel features of the present disclosure are set forth in the appended claims, the present disclosure will be better understood by the following detailed description with the drawings, both as to configuration and content, in conjunction with other objects and features of the present disclosure.

### BRIEF DESCRIPTION OF THE DRAWINGS

FIG. 1 is a side perspective view schematically illustrating a solid electrolytic capacitor according to a first exemplary embodiment;

FIG. 2 is a side cross-sectional view schematically illustrating a capacitor element; and

FIG. 3 is a perspective view schematically illustrating a capacitor element; and

FIG. 4 is a side perspective view schematically illustrating a solid electrolytic capacitor according to a second exemplary embodiment.

### DETAILED DESCRIPTIONS OF EMBODIMENTS

In the surface mount capacitor disclosed in Unexamined Japanese Patent Publication No. 2009-076651, further improvement of noise filter characteristics is desired.

The present disclosure provides a solid electrolytic capacitor with improved noise filter characteristics.

Hereinafter, an exemplary embodiment of a solid electrolytic capacitor according to the present disclosure will be described by way of examples. However, the present disclosure is not limited to examples described below. In the following description, specific numerical values and materials may be exemplified, but other numerical values and materials may be applied as long as the effects of the present disclosure can be obtained.

The solid electrolytic capacitor according to the present disclosure can be used as, for example, a three-terminal transmission line component having a noise filter function. The solid electrolytic capacitor according to the present disclosure includes a plurality of capacitor elements, two anode terminals, a cathode terminal, and an outer packaging resin. The number of anode terminals may be two or more, and the number of cathode terminals may be one or more.

Each of the plurality of capacitor elements includes an anode body and a cathode part formed on a surface of the anode body via a dielectric layer. A part of the anode body protrudes from each of both ends opposite to each other of the cathode part. Hereinafter, the part of the anode body, which protrudes from a corresponding one of the both ends of the cathode part, is also referred to as a protrusion. The plurality of capacitor elements are stacked on each other. In each capacitor element, two protrusions of the anode body are electrically connected to each other. Each capacitor element further includes an insulator disposed between the anode body and the cathode part to electrically insulate the anode body and the cathode part from each other. The insulator may be, for example, an insulating tape or an insulating resin.

The anode body may be made of a valve metal. Examples of the valve metal constituting the anode body include aluminum, tantalum, niobium, and titanium. The anode body may be a foil of a valve metal or a sintered body of valve metal particles. The anode bodies adjacent to each other in the stacking direction may be electrically connected to each other.

The dielectric layer covers at least a part of the surface of the anode body. The dielectric layer may be an oxide (for example, aluminum oxide) formed on the surface of the anode body by a liquid phase method such as anodization or a gas phase method such as vapor deposition and atomic layer deposition. The dielectric layer is formed so as to be interposed at least between the anode body and the cathode part.

The cathode part may include a solid electrolyte layer covering at least a part of surface of the dielectric layer, and a cathode layer covering at least a part of the surface of the solid electrolyte layer. The cathode parts adjacent to each other in the stacking direction may be electrically connected to each other. The solid electrolyte layer may contain a conductive polymer. The solid electrolyte layer may further contain a dopant as necessary.

As the conductive polymer, a known polymer used for a solid electrolytic capacitor, such as a x-conjugated conductive polymer, may be used. Examples of the conductive polymer include polymers having, as a basic skeleton, polypyrrole, polythiophene, polyaniline, polyfuran, polyacetylene, polyphenylene, polyphenylene vinylene, polyacene, or polythiophene vinylene. Among these polymers, a polymer that has, as a basic skeleton, polypyrrole, polythiophene, or polyaniline is preferable. Also included in the above-mentioned polymers are a homopolymer, a copolymer of two or more types of monomers, and derivatives of these polymers (substitution products having a substituent group). For example, polythiophene includes poly(3,4-ethylenedioxythiophene) and the like. As the conductive polymer, one type may be used alone, or two or more types may be used in combination.

As a dopant, at least one selected from the group consisting of low molecular anions and polyanions is used, for example. Examples of low molecular anion include, but are not particularly limited to, a sulfate ion, a nitrate ion, a phosphate ion, a borate ion, an organic sulfonate ion, and a carboxylate ion. Examples of dopant that generates organic sulfonate ions include benzenesulfonic acid, p-toluenesulfonic acid, and naphthalenesulfonic acid. Examples of polyanion include, for example, a polymer-type polysulfonic acid, and a polymer-type polycarboxylic acid. Examples of polymer-type polysulfonic acid include a polyvinylsulfonic acid, a polystyrenesulfonic acid, a polyallylsulfonic acid, a polyacrylsulfonic acid, and a polymethacrylsulfonic acid. Examples of polymer-type polycarboxylic acid include a polyacrylic acid and a polymethacrylic acid. Polyanions also include a polyester sulfonic acid and a phenolsulfonic acid novolak resin. However, polyanions are not limited to those listed above.

The solid electrolyte layer may further contain a known additive agent and a known conductive material other than conductive polymers as necessary. Examples of such a conductive material include at least one selected from the group consisting of conductive inorganic materials such as manganese dioxide and TCNQ complex salts.

The cathode layer may include a carbon layer formed on a surface of the solid electrolyte layer and a conductive material layer formed on a surface of the carbon layer. The conductive material layer may include silver paste. As the silver paste, a composition containing silver particles and a resin component (binder resin) may be used, for example. As the resin component, a thermoplastic resin may be used, but it is preferable to use a thermosetting resin such as an imide resin and an epoxy resin.

Each of the two anode terminals is electrically connected to a corresponding one of the two protrusions of the anode body. In other words, one anode terminal (first anode terminal) is electrically connected to the protrusion protruding from one end of the cathode part, and the other anode terminal (second anode terminal) is electrically connected to the protrusion protruding from the other end of the cathode part. Each of the first anode terminal and the second anode terminal may be divided into two or more parts. The anode terminal may be made of copper, a copper alloy, aluminum, or an aluminum alloy, or may be plated. The first anode terminal and the second anode terminal may be electrically connected to the two protrusions of each anode body of the plurality of capacitor elements. The anode terminal may be electrically connected to the protrusion by caulking, or may be electrically connected to the protrusion by welding (for example, laser welding or resistance welding).

The cathode terminal is electrically connected to the cathode part. The cathode terminal may be electrically connected to each cathode part of the plurality of capacitor elements. The cathode terminal may be electrically connected to the cathode part via a conductive adhesive. The cathode terminal may be made of copper, a copper alloy, aluminum, or an aluminum alloy, or may be plated. The constituent material of the cathode terminal may be the same as or different from the constituent material of the anode terminal. The cathode terminal may be divided into two or more parts.

The outer packaging resin covers the plurality of capacitor elements, the anode terminals, and the cathode terminal such that a part of each of the anode terminals and a part the cathode terminal are exposed from the outer packaging resin. Each of the exposed portions of the anode terminals and the cathode terminal functions as an external terminal of the solid electrolytic capacitor. The outer packaging resin may be made of an insulating resin material. The outer packaging resin may be, for example, a cured product of a thermosetting resin containing an epoxy resin, and may contain a filler as necessary.

The cathode part includes a first portion having a first width and a second portion having a second width smaller than the first width. Here, the width direction of the cathode part refers to a direction orthogonal to the stacking direction of the plurality of capacitor elements and orthogonal to the direction connecting the two protrusions. Hence, when the solid electrolytic capacitor according to the present disclosure is used as a transmission line component, the width direction of the cathode part is orthogonal to a direction in which the main path of the current flowing in the solid electrolytic capacitor extends. In other words, the second portion of the cathode part constitutes a portion where the main path of the current narrows. Then, it has been found that a noise current is not likely to pass through such a narrow part.

The cathode terminal includes a first side wall electrically connected to a side surface of the second portion in the cathode part. The first side wall may be electrically connected to a side surface of the second portion of each cathode part. The first side wall may be electrically connected to the side surface of the second portion of each cathode part via a conductive adhesive. The presence of such a first side wall reduces the impedance derived from the resistance component and the inductance component of the cathode terminal, and can improve the noise filter characteristics of the solid electrolytic capacitor.

Hence, in the solid electrolytic capacitor according to the present disclosure, noise filter characteristics can be improved by the second portions each forming the narrow part and the first side wall electrically connected to the side surface of the second portion.

W2/W1≤0.95 may be satisfied where W1 represents the first width and W2 represents the second width. Furthermore, 0.5≤W2/W1≤0.95 may be satisfied. When W2/W1≤0.95 is satisfied, the effect of improving the noise filter characteristics by providing the second portions is sufficiently achieved. When W2/W1≥0.5 is satisfied, it is possible to avoid an area of each capacitor element or a capacitance of the solid electrolytic capacitor to be too small while obtaining such an effect of improving the noise filter characteristics.

Opposite side surfaces of each capacitor element may each have a recess corresponding to the second portion. In this case, the opposite side surfaces of the capacitor element each have a step as a barrier against noise current flowing in the solid electrolytic capacitor. This makes it possible to further improve the noise filter characteristics of the solid electrolytic capacitor.

Two first side walls may be provided, each of which corresponds to a side surface of the capacitor element. Each of the two first side walls may be housed in the recess. According to this configuration, since the first side wall do not protrude from the side surface of the capacitor element, the internal space of the solid electrolytic capacitor can be effectively utilized to increase the capacitance of the solid electrolytic capacitor. The shape of each of the two first side walls is not limited, and may be formed by, for example, a plurality of columnar portions.

The cathode terminal may further include a second side wall electrically connected to the side surface of the first portion of the cathode part. This makes it possible to further reduce the impedance derived from the resistance component and the inductance component of the cathode terminal, and further improve the noise filter characteristics of the solid electrolytic capacitor.

As described above, according to the present disclosure, the noise filter characteristics of the solid electrolytic capacitor can be improved by the second portion having a narrow width and the first side wall electrically connected to a side surface of the second portion.

Hereinafter, examples of the solid electrolytic capacitor according to the present disclosure will be specifically described with reference to the drawings. The components described above may be applied to components of the solid electrolytic capacitor of the examples to be described below. The components of the solid electrolytic capacitor of the examples to be described below can be changed based on the above description. Matters described below may be applied to the exemplary embodiment described above. Among the components of the solid electrolytic capacitor of the examples to be described below, components may be omitted that are not essential to the solid electrolytic capacitor according to the present disclosure. Note that the following drawings are schematic and do not accurately reflect the shape and number of actual members.

### First Exemplary Embodiment

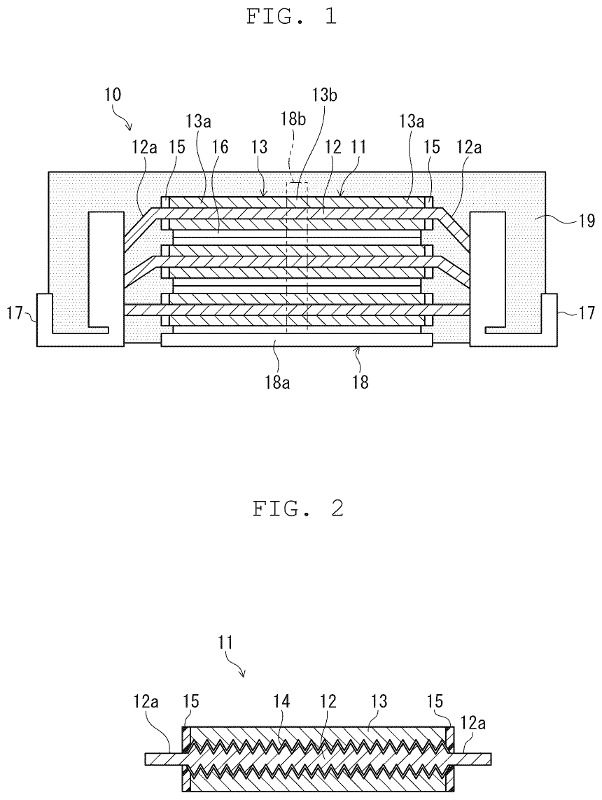

A first exemplary embodiment of the present disclosure will be described. As shown in FIGS. 1 to 3, solid electrolytic capacitor 10 of the present exemplary embodiment includes a plurality of (in this example, three) capacitor elements 11, two anode terminals 17, cathode terminal 18, and outer packaging resin 19. In FIG. 1, first side wall 18b to be described below is indicated by a two-dot chain line.

Each of the plurality of capacitor elements 11 has anode body 12 and cathode part 13 formed on a surface of anode body 12 via dielectric layer 14. A part of anode body 12 protrudes from each of both ends (left and right ends in FIG. 1) opposite to each other of cathode part 13. Hereinafter, the part of anode body 12 protruding from a corresponding one of the both ends of cathode part 13 is also referred to as protrusion 12a. The plurality of capacitor elements 11 are stacked on each other. In each capacitor element 11, two protrusions 12a of anode body 12 are electrically connected to each other. Each capacitor element 11 further includes insulator 15 disposed between anode body and cathode part 13 to electrically insulate anode body 12 and cathode part from each other.

Anode body 12 is made of a foil of a valve metal (in this example, aluminum), but is not limited thereto. Anode bodies 12 adjacent to each other in the stacking direction are electrically connected to each other. Therefore, all anode bodies 12 are electrically connected to each other.

Dielectric layer 14 covers at least a part of a surface of anode body 12. Dielectric layer 14 is made of oxide (in this example, aluminum oxide) formed on the surface of anode body 12 subjected to the roughening treatment, but is not limited thereto.

Cathode part 13 includes a solid electrolyte layer covering at least a part of the dielectric layer 14, and a cathode layer covering at least a part of the solid electrolyte layer. Cathode parts 13 adjacent to each other in the stacking direction are electrically connected to each other via conductive paste 16. Accordingly, all cathode parts 13 are electrically connected to each other. The solid electrolyte layer contains a conductive polymer and a dopant.

Cathode layer includes a carbon layer formed on the surface of the solid electrolyte layer and a conductive material layer formed on the surface of the carbon layer. The conductive material layer may include silver paste.

Each of two anode terminals 17 is electrically connected to a corresponding one of two protrusions 12a of anode body 12. Anode terminal 17 is made of a copper alloy, but are not limited thereto. Anode terminal 17 is electrically connected to protrusion 12a by caulking. Meanwhile, anode terminal 17 may be welded to protrusion 12a instead of or in addition to the caulking.

Cathode terminal 18 is electrically connected to cathode part 13 via, for example, a conductive adhesive. Cathode terminal 18 is made of a copper alloy, but is not limited thereto. The constituent material of cathode terminal 18 is the same as the constituent material of anode terminal 17.

Outer packaging resin 19 covers the plurality of capacitor elements 11 and anode terminals 17, and cathode terminal 18 such that a part of anode terminals 17 and a part of cathode terminal 18 are exposed from outer packaging resin 19. Each of exposed portions of anode terminals 17 and cathode terminal 18 functions as an external terminal of solid electrolytic capacitor 10. The outer packaging resin 19 is made of an insulating resin material containing a filler.

Cathode part 13 has first portion 13a having a first width and second portion 13b having a second width smaller than the first width. Second portion 13b is preferably placed at the center of cathode part 13 in the longitudinal direction of cathode part 13 (a direction identical to the direction connecting two protrusions 12a). Two first portions 13a may be provided so as to sandwich second portion 13b in the longitudinal direction of cathode part 13.

W2/W1≤0.95 is preferably satisfied where W1 represents the first width and W2 represents the second width, and 0.5≤W2/W1≤0.95 is more preferably satisfied.

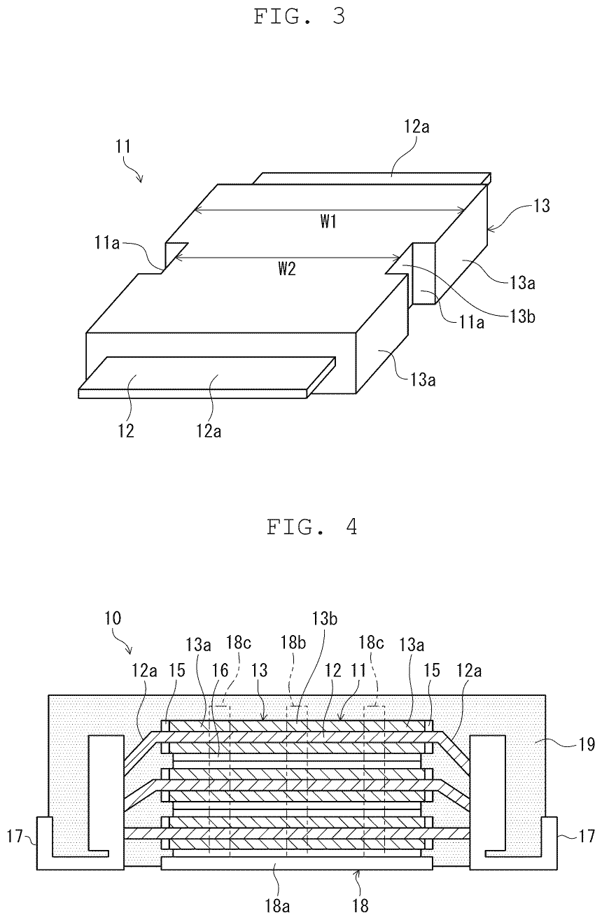

Opposite side surfaces of each capacitor element 11 preferably each have recess 11a corresponding to second portion 13b. Recess 11a preferably has a rectangular shape or a trapezoidal shape (in particular, a trapezoidal shape that decreases the width toward the center in the width direction of capacitor element 11) as viewed in the stacking direction of the plurality of capacitor elements 11. FIG. 3 illustrates capacitor element 11 in which rectangular recesses 11a are formed.

Cathode terminal 18 has mounting surface 18a exposed from outer packaging resin 19, and first side wall 18b that rises continuously from mounting surface 18a and is electrically connected to a side surface of second portion 13b of each cathode part 13. Mounting surface 18a is electrically connected to cathode part 13 of closest (lowermost in FIG. 1) capacitor element 11. First side wall 18b is electrically connected to a side surface of second portion 13b of each cathode part 13 via a conductive adhesive (not illustrated). First side wall 18b may be housed in recess 11a.

### Second Exemplary Embodiment

A second exemplary embodiment of the present disclosure will be described. Solid electrolytic capacitor 10 according to the present exemplary embodiment is different from the first exemplary embodiment in that second side wall 18c is provided. Hereinafter, differences from the first exemplary embodiment will be mainly described.

As shown in FIG. 4, cathode terminal 18 has second side walls 18c that rise continuously from mounting surface 18a and are electrically connected to side surfaces of first portions 13a of each cathode part 13. The width (dimension in left-right direction in FIG. 4) of second side wall 18c may be smaller or larger than the width of first side wall 18b, or may be the same as the width of first side wall 18b.

### SUPPLEMENTARY NOTE

The above description of the exemplary embodiment discloses techniques below.

### Technique 1

A solid electrolytic capacitor, including:
a plurality of capacitor elements stacked on each other, each of the plurality of capacitor elements including an anode body and a cathode part formed on a surface of the anode body via a dielectric layer;
two anode terminals electrically connected the anode body;
a cathode terminal electrically connected to the cathode part; and
an outer packaging resin that covers the plurality of capacitor elements, the anode terminals, and the cathode terminal so that a part of each of the anode terminals and a part of the cathode terminal are exposed from the outer packaging resin,
wherein:
the anode body has two protrusions, one of the two protrusions protruding from one of both ends of the cathode part, another one of the two protrusions protruding from another one of the both ends of the cathode part,
each of the two protrusions is electrically connected to a corresponding one of the two anode terminals,
the two protrusions in each of the capacitor elements are electrically connected to each other,
the cathode part includes a first portion having a first width and a second portion having a second width smaller than the first width, and
the cathode terminal includes a first side wall electrically connected to a side surface of the second portion in the cathode part.

### Technique 2

The solid electrolytic capacitor according to Technique 1, wherein a relational expression of W2/W1≤0.95 is satisfied, where W1 represents the first width and W2 represents the second width.

### Technique 3

The solid electrolytic capacitor according to Technique 2, wherein a relational expression of 0.5≤W2/W1≤0.95 is satisfied.

### Technique 4

The solid electrolytic capacitor according to any one of Techniques 1 to 3, wherein opposite side surfaces of each of the plurality of capacitor elements each have a recess corresponding to the second portion.

### Technique 5

The solid electrolytic capacitor according to any one of Techniques 1 4, wherein the cathode terminal further includes a second side wall electrically connected to a side surface of the first portion of the cathode part.

### Technique 6

The solid electrolytic capacitor according to any one of Techniques 1 to 5, wherein the cathode part includes a solid electrolyte layer that covers at least a part of the dielectric layer, the solid electrolyte layer containing a conductive polymer.

### EXAMPLES

Solid electrolytic capacitors 10 of an example and a comparative example described below were each subjected to characteristic evaluation. Specifically, for solid electrolytic capacitors 10 of the example and the comparative example, each noise reduction amount was evaluated when a noise signal of 100 MHz was input from one anode terminal 17 to another anode terminal 17.

### Examples

Solid electrolytic capacitor 10 of the type illustrated in the above first exemplary embodiment was evaluated. The noise reduction amount was −120 dB. The noise level was 25%, where the noise level of the solid electrolytic capacitor of the comparative example was 100%.

### Comparative Example

A solid electrolytic capacitor was evaluated that has the same configuration as solid electrolytic capacitor 10 of the example except that cathode part 13 does not have second portion 13b. Here, the width of cathode part 13 was constant, and was equal to the width of second portion 13b of solid electrolytic capacitor 10 of the example. The noise reduction amount was −108 dB.

As described above, the solid electrolytic capacitor 10 of the example had a remarkably higher noise reduction amount than the solid electrolytic capacitor of the comparative example. This demonstrates superiority of the example.

Although the present disclosure is described in terms of the preferred exemplary embodiment at present, such disclosure should not be construed in a limiting manner. Various modifications and alterations will undoubtedly be apparent to those skilled in the art belonging to the present disclosure by reading the above disclosure. Therefore, the scope of claims appended is to be construed to cover all modifications and alterations without departing from the true spirit and scope of the present disclosure.

The present disclosure is applicable to a solid electrolytic capacitor.

What is claimed is:

1. A solid electrolytic capacitor comprising:
a plurality of capacitor elements stacked on each other, each of the plurality of capacitor elements including an anode body and a cathode part formed on a surface of the anode body via a dielectric layer;
two anode terminals electrically connected to the anode body;
a cathode terminal electrically connected to the cathode part; and
an outer packaging resin that covers the plurality of capacitor elements, the two anode terminals, and the cathode terminal so that a part of each of the two anode terminals and a part of the cathode terminal are exposed from the outer packaging resin,
wherein:
the anode body has two protrusions, one of the two protrusions protruding from one of both ends of the cathode part, another one of the two protrusions protruding from another one of the both ends of the cathode part,
each of the two protrusions is electrically connected to a corresponding one of the two anode terminals,
the two protrusions in each of the plurality of capacitor elements are electrically connected to each other,
the cathode part includes a first portion having a first width and a second portion having a second width smaller than the first width, and
the cathode terminal includes a first side wall electrically connected to a side surface of the second portion in the cathode part.

2. The solid electrolytic capacitor according to claim 1, wherein a relational expression of W2/W1≤0.95 is satisfied, where W1 represents the first width and W2 represents the second width.

3. The solid electrolytic capacitor according to claim 2, wherein a relational expression of 0.5≤W2/W1≤0.95 is satisfied.

4. The solid electrolytic capacitor according to claim 1, wherein opposite side surfaces of each of the plurality of capacitor elements each have a recess corresponding to the second portion.

5. The solid electrolytic capacitor according to claim 1, wherein the cathode terminal further includes a second side wall electrically connected to a side surface of the first portion of the cathode part.

6. The solid electrolytic capacitor according to claim 1, wherein the cathode part includes a solid electrolyte layer that covers at least a part of the dielectric layer, the solid electrolyte layer containing a conductive polymer.
